(19) United States
(12) Patent Application Publication
(10) Pub. No.: US 2025/0121919 A1
(43) Pub. Date: Apr. 17, 2025

(54) REGULATOR ASSEMBLY WITH DETECTING DEVICE AND METHOD FOR OPERATING THE SAME

(71) Applicant: EOPI CO., LTD, New Taipei City (TW)

(72) Inventor: HUNG RU CHEN, Taipei City (TW)

(73) Assignee: EOPI CO., LTD, New Taipei City (TW)

(21) Appl. No.: 18/911,179

(22) Filed: Oct. 9, 2024

Related U.S. Application Data
(60) Provisional application No. 63/543,914, filed on Oct. 12, 2023.

(51) Int. Cl. B63C 11/22; B63C 11/18

(52) U.S. Cl. CPC B63C 11/2209; B63C 2011/188

(57) ABSTRACT

A detecting device of a regulator assembly includes a chamber, a warning unit, and a switch member. The warning unit is movably installed in the chamber. When the switch member is in a first state, the switch member blocks a predetermined inlet of the chamber. When the switch member changes from the first state to a second state, the switch member does not block the predetermined inlet of the chamber. The present disclosure further provides a method for operating a regulator assembly.

### CROSS-REFERENCE TO RELATED APPLICATION(S)

This application claims the benefit of and priority to the U.S. Provisional Patent Application No. 63/543,914, filed on Oct. 12, 2023, the disclosure of which is incorporated herein by reference in the entirety.

### FIELD

The present disclosure relates to a regulator, and more particularly, to a regulator with a detecting device.

### BACKGROUND

Generally, users, such as divers, need scuba tanks to conduct diving activities. The compressed air inside the scuba tanks cannot be directly breathed by the divers. Therefore, the compressed air typically needs to be depressurized through regulators, such as a first stage regulator and a second stage regulator, to ambient pressure air which the divers can breathe.

Moreover, in current technology, the divers need to use a pressure gauge (residual pressure gauge) connected to the first stage regulator through a pipeline and check the information shown in the gauge to determine the remaining air in the tank. However, with various market demands, how to develop alternative regulator products has become an issue that cannot be overlooked.

### SUMMARY

The present disclosure relates to a regulator with a detecting device.

According to one aspect, a regulator assembly for an air supply device is provided. The regulator assembly includes a main body and a detecting device. The main body includes an air channel, and the air channel is connected to the air supply device. The detecting device is arranged to the main body, and the detecting device includes an inlet portion, a chamber, a warning unit, and a switch member. The inlet portion is connected to the main body and communicates with the air channel. The warning unit is arranged in the chamber. The switch member is movably installed adjacent to the inlet portion. When the switch member is in a first state, the switch member prevents air provided by the air supply device from entering the chamber. When the switch member changes from the first state to a second state, the switch member allows the air to enter the chamber, and the air drives the warning unit.

According to another aspect, a detecting device includes a chamber, a warning unit, and a switch member. The warning unit is movably installed in the chamber. When the switch member is in a first state, the switch member blocks a predetermined inlet of the chamber. When the switch member changes from the first state to a second state, the switch member does not block the predetermined inlet of the chamber. A movement direction of the warning unit is substantially the same as a movement direction of the switch member.

According to another aspect, a method for operating a regulator assembly includes steps of providing a regulator assembly comprising a main body and a detecting device arranged in the main body, wherein the detecting device includes a switch member, an elastic member, and a warning unit; connecting an air channel of the main body to an air supply device; in response to air provided by the air supply device being in a high-pressure state, driving the switch member to be in a first state by the air, and pressing the elastic member by the switch member to accumulate a predetermined elastic force; and in response to the air provided by the air supply device being transformed from the high-pressure state to a low-pressure state due to consumption, the switch member changing from the first state to a second state in response to release of the predetermined elastic force of the elastic member, and the warning unit emitting a warning signal.

### BRIEF DESCRIPTION OF THE DRAWINGS

FIG. 1 shows a schematic diagram of a regulator assembly, which is installed to an air supply device, according to a first embodiment of the present disclosure.

FIG. 2 shows a perspective schematic diagram of the regulator assembly, which includes a detecting device, according to the first embodiment of the present disclosure.

FIG. 3 shows a cross-sectional schematic diagram of the detecting device according to the first embodiment of the present disclosure.

FIG. 4a shows an exploded schematic diagram of the detecting device in one view angle according to the first embodiment of the present disclosure.

FIG. 4b shows an exploded schematic diagram of the detecting device in another view angle according to the first embodiment of the present disclosure.

FIG. 5 shows a schematic diagram of a first operation of the detecting device according to the first embodiment of the present disclosure.

FIG. 6 shows a schematic diagram of a second operation of the detecting device according to the first embodiment of the present disclosure.

FIG. 7 shows a schematic diagram of a method for operating the regulator assembly according to the first embodiment of the present disclosure.

FIG. 8 shows a block diagram of a regulator assembly, which is installed to the air supply device, according to a second embodiment of the present disclosure.

### DETAILED DESCRIPTION

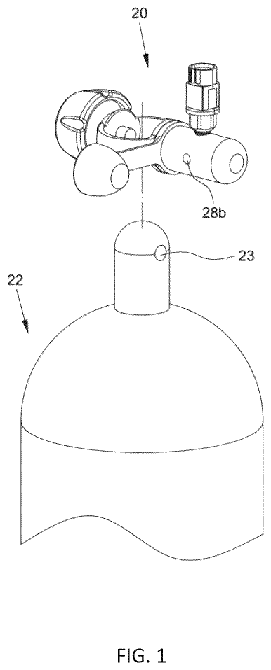

As shown in FIG. 1, a regulator assembly 20 of a first embodiment of the present disclosure can be installed to an air supply device 22. The air supply device 22 is, for example, a scuba tank. The regulator assembly 20 is configured to decompress the compressed air provided by the air supply device 22.

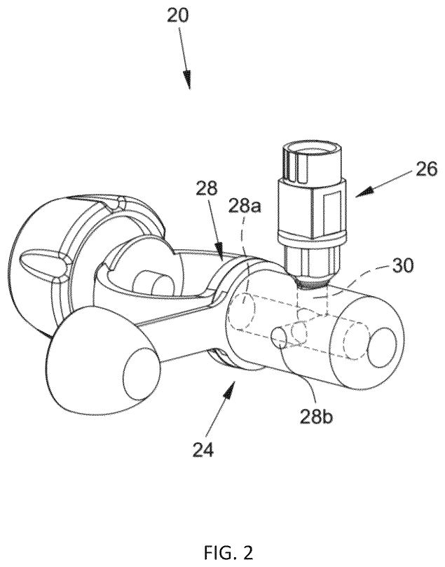

As shown in FIG. 1 and FIG. 2, the regulator assembly 20 includes a main body 24 and a detecting device 26.

The main body 24 is, for example, a first stage regulator, however the implementation is not limited thereto. The main body 24 includes an air channel 28, and the air channel 28 includes an air pressure inlet terminal 28a and an air pressure outlet terminal 28b. The air pressure inlet terminal 28a of the air channel 28 is connected to an air outlet hole 23 of the air supply device 22, and the air pressure outlet terminal 28b is configured to connect the air which is obtained through first decompression performed by the internal mechanism (not shown) of the main body 24 to a second stage regulator through a pipeline, so that the second stage regulator can perform second decompression on the air which has been decompressed by the first decompression. A user (such as a diver) can breathe by receiving the air which has been decompressed by the second stage regulator through a breathing device. Since this part is a technical category that can be understood by those with ordinary knowledge in the technical field, for the sake of simplicity, no further details will be described here.

The detecting device 26 is arranged to the main body 24. Furthermore, the detecting device 26 is connected to (for example, detachably connected to, screwed to, or snapped in) the main body 24, or the detecting device 26 may be integrated into the main body 24, however, the implementation is not limited thereto. The detecting device 26 includes an inlet portion 30. Preferably, the detecting device 26 is connected to the main body 24 through the inlet portion 30 and communicates with the air pressure inlet terminal 28a of the air channel 28 of the main body 24.

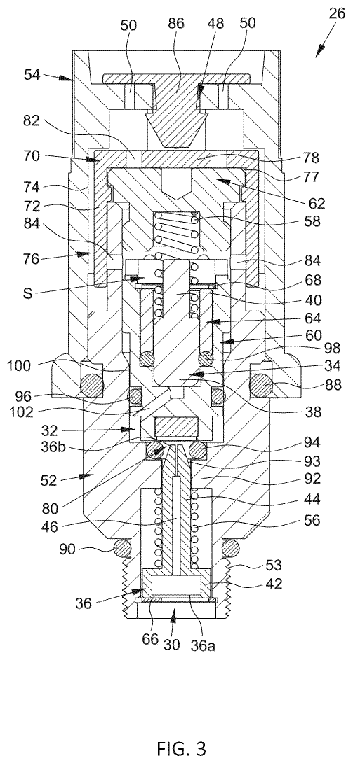

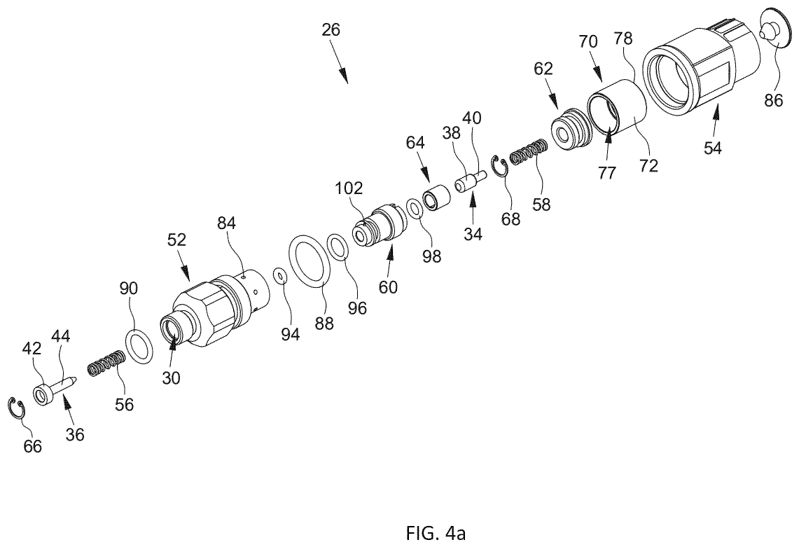

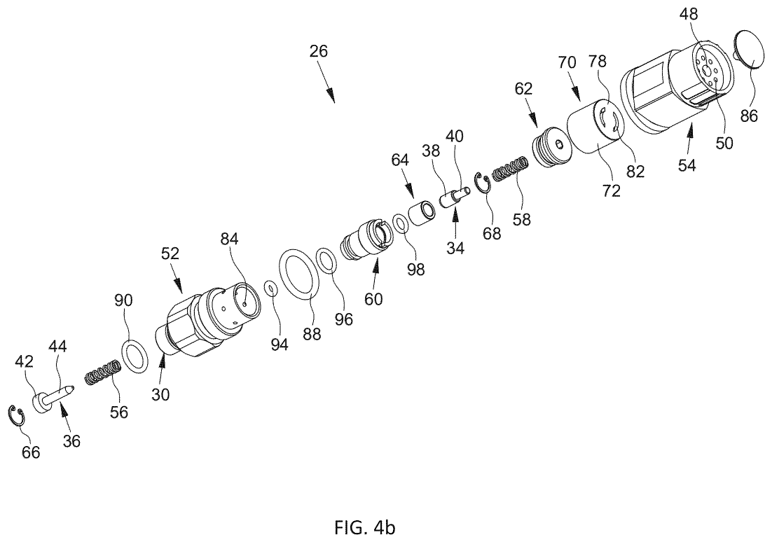

As shown in FIG. 3, FIG. 4a, and FIG. 4b, the detecting device 26 further includes a chamber 32, a warning unit 34 and a switch member 36. The warning unit 34 is arranged in the chamber 32. In the embodiment, the warning unit 34 is taken as a piston as an example, however the implementation is not limited thereto. Preferably, the warning unit 34 includes a head portion 38 and a body portion 40 extending from the head portion 38. The size of the head portion 38 is greater than the size of the body portion 40.

The switch member 36 is movably installed adjacent to the inlet portion 30. In the embodiment, the switch member 36 is taken as a plug as an example. The switch member 36 includes a first terminal 36a and a second terminal 36b which are located opposite to each other. The second terminal 36b preferably includes a head section 42 and a body section 44 extending from the head section 42. The size of the head section 42 is greater than the size of the body section 44. Furthermore, the switch member 36 is a hollow plug. For example, a predetermined channel 46 is defined between the first terminal 36a and the second terminal 36b of the switch member 36 so that the first terminal 36a and the second terminal 36b of the switch member 36 communicate with each other. In an alternative embodiment, the switch member 36 is a non-hollow plug. Thus, the implementation of the switch member 36 is not limited.

Preferably, the detecting device 26 further includes an outlet portion 48, and the chamber 32 is located between the inlet portion 30 and the outlet portion 48. In addition, at least one opening 50 is formed adjacent to the outlet portion 48 as an example, however the implementation is not limited therefor.

Preferably, the detecting device 26 further includes at least one housing. In the embodiment, a first housing 52 and a second housing 54 are taken as examples. Furthermore, the first housing 52 and the second housing 54 are connected to each other (for example, jointed to each other), however the implementation is not limited therefore. The first housing 52 is provided with the inlet portion 30, the second housing 54 is provided with the outlet portion 48 and the opening 50, and the chamber 32 is formed between the inlet portion 30 and the outlet portion 48.

Preferably, the first housing 52 has screw threads 53 located adjacent to the periphery of the inlet portion 30 (as shown in FIG. 3), which can be screwed to the main body 24.

Preferably, the detecting device 26 further includes a first elastic member 56 for providing elastic force to the switch member 36 and a second elastic member 58 for providing an elastic force to the warning unit 34.

Preferably, the detecting device 26 further includes a first base 60 and a second base 62 which are arranged in the chamber 32. A predetermined space S is defined between the first base 60 and the second base 62 and provided for the warning unit 34 to move.

Preferably, the detecting device 26 further includes a retainer member 64 arranged in the predetermined space S. The retainer member 64 is configured to guide and facilitate the warning unit 34 on the path of movement.

Preferably, the detecting device 26 further includes a first stopper 66 and a second stopper 68. The first stopper 66 and the second stopper 68 are both, for example, C-shaped retainer rings, however the implementation is not limited thereto. The first stopper 66 is installed in the inlet portion 30 of the first housing 52, and the position of the first stopper 66 corresponds to the head section 42 of the switch member 36 for limiting the position of the switch member 36 to the inlet portion 30. On the other hand, the second stopper 68 is installed on the first base 60, and the second stopper 68 corresponds to the retainer member 64 to stabilize the position of the retainer member 64.

Preferably, compared to the second base 62, the first base 60 is closer to the inlet portion 30. On the other hand, compared to the first base 60, the second base 62 is closer to the outlet portion 48.

Preferably, the first elastic member 56 is against the head section 42 of the switch member 36 and the first housing 52, and the second elastic member 58 is against the head portion 38 of the warning unit 34 and the second base 62.

Preferably, the detecting device 26 further includes an auxiliary member 70, such as a film. Furthermore, the auxiliary member 70 is made of flexible material, so that the auxiliary member 70 can be slightly bent and deformed. The auxiliary member 70 is located between the chamber 32 and the outlet portion 48. The auxiliary member 70 includes at least one predetermined section 72, and a predetermined gap 76 is defined between the auxiliary member 70 and an inner wall 74 of the second housing 54. The predetermined gap 76 is provided for the predetermined section 72 of the auxiliary member 70 to move within the predetermined gap 76.

Preferably, the size of the auxiliary member 70 is greater than the size of the second base 62, the auxiliary member 70 has an auxiliary space 77, and the auxiliary member 70 is sleeved to the periphery of the second base 62 through the auxiliary space 77. The auxiliary member 70 further includes a base 78. The predetermined section 72 is connected to the base 78 to form an annular cylinder structure, and the base 78 and the predetermined section 72 jointly define the auxiliary space 77.

Preferably, the chamber 32 includes a predetermined inlet 80 and at least one predetermined outlet 82. The predetermined inlet 80 is located adjacent to the second terminal 36b of the switch member 36, and the at least one predetermined outlet 82 is formed on the base 78 and thus adjacent the outlet portion 48.

Preferably, the first housing 52 includes at least one predetermined hole 84 communicating with the predetermined space S, and the position of the predetermined hole 84 corresponds to the predetermined section 72 of the auxiliary member 70.

Preferably, the outlet portion 48 of the detecting device 26 is provided with a valve member 86, such as a reverse valve, and the valve member 86 is made of rubber or plastic, however the implementation is not limited thereto.

Preferably, the detecting device 26 further includes a plurality of air-tight washer rings (O-rings), including a first air-tight washer ring 88 and a second air-tight washer ring 90. The first air-tight washer ring 88 is sleeved on the periphery of the first housing 52, which facilitates improving the air tightness between the first housing 52 and the second housing 54. The second air-tight washer ring 90 is sleeved on the periphery of the inlet portion 30 of the first housing 52, which facilitates improving the air tightness of the detecting device 26 when the detecting device 26 is connected to the main body 24 through the inlet portion 30.

Preferably, the first housing 52 has a support section 92 located between the inlet portion 30 and the chamber 32, and the body section 44 of the switch member 36 can pass through a through hole 93 in the middle of the support section 92 and then partially enter the chamber 32.

Preferably, the detecting device 26 further includes a third air-tight washer ring 94 which is located in the chamber 32 and adjacent to the predetermined inlet 80 of the chamber 32, and the third air-tight washer ring 94 is arranged between the support section 92 and the first base 60, which facilitates improving the air tightness between the support section 92 and the first base 60.

Preferably, the detecting device 26 further includes a fourth air-tight washer ring 96 and a fifth air-tight washer ring 98. The fourth air-tight washer ring 96 is sleeved on the periphery of the first base 60, which facilitates improving the air tightness between the first base 60 and an inner wall 100 of the first housing 52. The air-tight washer ring 98 is arranged between the retainer member 64 and the first base 60, which facilitates improving the airtightness of the predetermined space S.

Preferably, the first base 60 includes an auxiliary hole 102 which communicates with the chamber 32 and the predetermined space S.

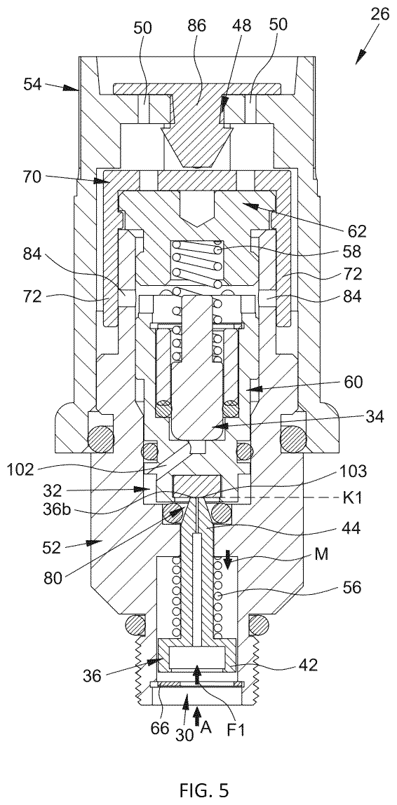

As shown in FIG. 5, when the switch member 36 is in a first state K1, the switch member 36 is configured to prevent air A provided by the air supply device 22 from entering the chamber 32.

Furthermore, when the air A provided by the air supply device 22 is in a high-pressure state, the air A enters through the inlet portion 30 of the detecting device 26 with a first air pressure force F1, and the switch member 36 is driven to be in the first state K1 with a first air pressure force F1. At this time, the switch member 36 presses the first elastic member 56 with the head section 42 to accumulate a predetermined elastic force M, wherein the direction of the predetermined elastic force M is opposite to the direction of the first air pressure force F1. Preferably, when the switch member 36 is in the first state K1, the body portion 44 of the switch member 36 (or the second terminal 36b of the switch member 36) blocks the predetermined inlet 80 of the chamber 32 to block the air A from entering the chamber 32, so that the air A cannot drive the warning unit 34. The second terminal 36b of the switch member 36 abuts against a corresponding portion 103 of the first base 60 away from the warning unit 34.

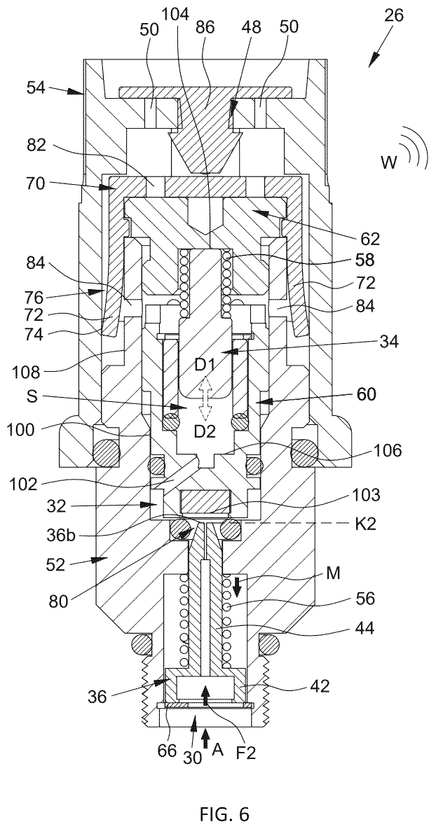

As shown in FIG. 6, when the switch member 36 changes from the first state K1 to a second state K2, the switch member 36 is configured to allow the air A to enter the chamber 32, and the air A drives the warning unit 34.

Furthermore, when the air A provided by the air supply device 22 is in a low-pressure state, the first air pressure force F1 decreases to a second air pressure force F2, and the predetermined elastic force M is greater than the second air pressure force F2, so that the switch member 36 changes from the first state K1 to the second state K2 in response to the release of the predetermined elastic force M of the first elastic member 56. Preferably, when the switch member 36 is in the second state K2, the body portion 44 of the switch member 36 or the second terminal 36b of the switch member 36 does not block the predetermined inlet 80 of the chamber 32, which allows the air A to enter the chamber 32, so that the air A drives the warning unit 34. The second terminal 36b of the switch member 36 no longer abuts against the corresponding portion 103 of the first base 60.

Preferably, when the air A enters the chamber 32, the air A can enter the predetermined space S through the auxiliary hole 102 and then drive the warning unit 34 to move in a first direction D1. When the warning unit 34 moves, it hits a first predetermined portion 104 of one of the first base 60 and the second base 62 to emit a warning sound. Preferably, in response to the elastic force of the second elastic member 58, the warning unit 34 moves in a second direction D2 opposite to the first direction D1, and the warning unit 34 can hit a second predetermined portion 106 of the other of the first base 60 and the second base 62 to emit another warning sound. Accordingly, the warning unit 34 can continuously reciprocate in the first direction D1 and the second direction D2 and hit the first predetermined portion 104 and the second predetermined portion 106 to emit the warning sounds W. Therefore, when the air A provided by the air supply equipment 22 is transformed from the high-pressure state to the low-pressure state due to consumption, the warning sounds W can alert the user that the capacity of the air A in the air supply device 22 has been reduced to a predetermined level, thereby achieving a warning effect.

Preferably, when the switch member 36 is in the second state K2, the switch member 36 is configured to allow the air A to enter the chamber 32. In the process that the air A flows from the chamber 32 to the outlet portion 48 or the opening 50, the air A enters the predetermined gap 76 from the predetermined space S through the predetermined hole 84. The air A drives the predetermined section 72 of the auxiliary member 70 to continuously move in the predetermined gap 76, so that the predetermined section 72 of the auxiliary member 70 can flap an outer wall 108 of the first housing 52 and the inner wall 74 of the second housing 54 to generate another warning sound. In the process that the air A drives the predetermined section 72 of the auxiliary member 70 to continuously move (for example, swing) in the predetermined gap 76, a resonance effect is also induced by the reciprocating warning unit 34. Accordingly, for example, the tone of the warning sound W can be raised, which facilitates improving the warning effect.

Preferably, the position of the outer wall 108 of the first housing 52 is opposite to the position of the inner wall 100 of the first housing 52.

Preferably, the air A is also discharged out of the detecting device 26 from the opening 50 through the predetermined outlet 82 of the base 78 of the auxiliary member 70.

Preferably, the movement direction of the warning unit 34 is substantially the same as the movement direction of the switch member 36. For example, the warning unit 34 and the switch member 36 can both move in the first direction D1 or the second direction D2.

Preferably, the warning unit 34 and the switch member 36 are linearly aligned with each other.

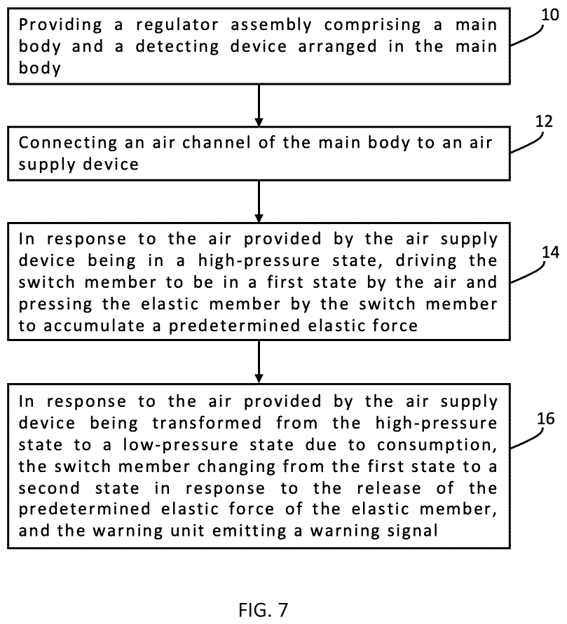

As shown in FIG. 7, the method for operating the regulator assembly of the present disclosure includes Step 10, Step 12, Step 14, and Step 16.

These steps are described as follows:
Step 10: providing a regulator assembly comprising a main body and a detecting device arranged in the main body, wherein the detecting device includes a switch member, an elastic member, and a warning unit.

In Step 10, referring to FIG. 2 and FIG. 3, the user can prepare the above-mentioned regulator assembly 20 includes the main body 24 and the detecting device 26 which is arrange to the main body 24, and the detecting device 26 includes the switch member 36, the first elastic member 56, and the warning unit 34.
Step 12: connecting an air channel of the main body to an air supply device.

In Step 12, referring to FIG. 1 and FIG. 2, the user can connect the air channel 28 of the main body 24 to the air outlet 23 of the air supply device 22.
Step 14: in response to air provided by the air supply device being in a high-pressure state, driving the switch member to be in a first state by the air, and pressing the elastic member by the switch member to accumulate a predetermined elastic force.

In Step 14, referring to FIG. 5, when the air A provided by the air supply device 22 is in a high-pressure state, the air A drives the switch member 36 to be in the first state K1, and the switch member 36 presses the first elastic member 56 to accumulate the predetermined elastic force M.
Step 16: in response to the air provided by the air supply device being transformed from the high-pressure state to a low-pressure state due to consumption, the switch member moving from the first state to a second state in response to the release of the predetermined elastic force of the elastic member, and the warning unit emitting a warning signal.

In Step 16, referring to FIG. 6, when the air A provided by the air supply device 22 is transformed from the high-pressure state to a low-pressure state due to consumption, the switch member 36 changes from the first state K1 to the second state K2 in response to the release of the predetermined elastic force M of the first elastic member 56, and the warning unit 34 is configured to emit the warning signal.

From the above method combined with the first embodiment, it can be known that the warning unit 34 emits the warning signal in a mechanical actuation manner. For example, the warning unit 34 is a piston, and the piston collides with the first base 60 and the first base 60 when moving, thereby emitting the warning sound W as the warning signal, as shown in FIG. 6.

Alternatively, in an alternative embodiment, the warning unit 34 may be an electronic unit capable of electronically emitting the warning signal, such as a sound and/or a light source (such as a flash) to alert the user. The first housing 52 and/or the second housing 54 may be made of transparent or translucent materials, so that the user can see the light source from outside the housing of the detecting device 26, or the emitted warning signal is a wireless signal that can be received by an electronic device (such as a smart watch) on the user, thereby alerting the user.

Therefore, when the air A provided by the air supply equipment 22 is transformed from the high-pressure state to the low-pressure state due to consumption, the user can be alerted to that the amount of the air A in the air supply device 22 has been reduced to a predetermined level, thereby achieving a warning effect.

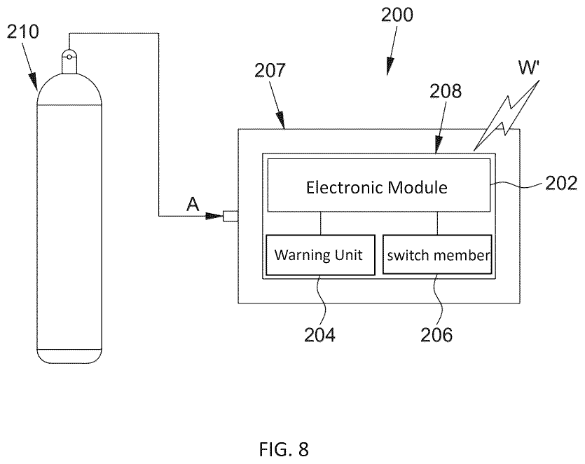

FIG. 8 shows a block diagram of a regulator assembly 200 according to a second embodiment of the present disclosure. The difference between the second embodiment and the first embodiment is that the regulator assembly 200 further includes an electronic module 202. The electronic module 202 can emit a predetermined signal W′ according to the activity of one of the warning unit 204 and the switch member 206. The detecting device 208 is connected to the main body 207, and main body 207 is, for example, a first stage regulator.

Furthermore, the electronic module 202 is arranged in a housing of the detecting device 208, and the electronic module 202 is configured to sense the activity of the warning unit 204 (such as a piston) or the switch member 206. The electronic module 202 includes electronic functional components or devices (not shown), including a control circuit board, and the control circuit board includes a sensing unit, a speaker unit, a light source unit, and/or a wireless transceiver unit.

For example, the electronic module 202 may be configured to sense the activity of the warning unit 204. When the air A provided by the air supply device 210 is in the low-pressure state, the air A drives the warning unit 204, and the electronic module 202 emits the predetermined signal W′ according to the sensed activity of the warning unit 204.

Preferably, the predetermined signal W′ includes a sound emitted by the speaker unit, or a light source (such as an LED light) emitted by the light source unit. The housing of the detecting device 208 may be made of transparent or translucent materials, so that the user can see the light source from outside the housing of the detecting device 208.

Preferably, the predetermined signal W′ is emitted from the wireless transceiver unit to the outside of the regulator assembly 200 for reception by an electronic device (such as a smart watch) on the user, thereby alerting the user.

Accordingly, when the air A provided by the air supply device 210 is transformed from the high-pressure state to the low-pressure state due to consumption, the user can be altered to that the amount of the air A in the air supply device 22 has been reduced to a predetermined level, thereby achieving a warning effect.

Alternatively, the electronic module 202 can be configured to sense the activity of the switch member 206. When the air A provided by the air supply device 210 is transformed from the high-pressure state to the low-pressure state due to consumption, the switch 206 changes from the first state K1 to the second state K2, and the electronic module 202 emits the predetermined signal W′ according to the sensed activity of the switch member 206, which can also achieve a warning effect.

Accordingly, the regulator assembly 20 of the embodiment of the present disclosure includes the following features:
1. In the first embodiment, the warning unit 34 of the detecting device 26 is driven to emit the warning sound W, which can alter the user (such as a diver) to that the air A in the air supply device 22 has been transformed from the high-pressure state to a low-pressure state due to consumption and the amount of the air A has been reduced to a predetermined level, thereby achieving a warning effect.
2. In the first embodiment, the warning unit 34 emits the warning signal in a mechanical actuation manner (as shown in FIG. 6). For example, the warning unit 34 collides with the first base 60 and the second base when the piston moves 62 to emit the warning sound W as the warning signal; or, in an alternative embodiment, the warning unit 34 can be an electronic unit that electronically emits the warning signal, such as a sound and/or a light source (such as flash) to alter the user; or, the emitted warning signal is a wireless signal which can be received by an electronic device (such as a smart watch) on the user, thereby alter the user. Therefore, when the air A provided by the air supply device 22 is transformed from the high-pressure state to the low-pressure state due to consumption, the user can be alerted to that the amount of the air A in the air supply device 22 has been reduced to a predetermined level, thereby achieving a warning effect.
3. In the second embodiment, the regulator assembly further includes an electronic module 202, and the electronic module 202 can emit the predetermined signal W′ according to the activity of one of the warning unit 204 (such as a piston) and the switch member 206. The predetermined signal W′ includes a sound or a light source. Alternatively, the predetermined signal W′ can be received by the electronic device on the user, thereby altering the user.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A regulator assembly for an air supply device, the regulator assembly comprising:
a main body comprising an air channel, wherein the air channel is connected to the air supply device; and
a detecting device arranged to the main body, wherein the detecting device comprises:
an inlet portion connected to the main body and communicating with the air channel;
a chamber;
a warning unit arranged in the chamber; and
a switch member movably installed adjacent to the inlet portion;
wherein when the switch member is in a first state, the switch member prevents air provided by the air supply device from entering the chamber, and
wherein when the switch member changes from the first state to a second state, the switch member allows the air to enter the chamber, and the air drives the warning unit.

2. The regulator assembly as claimed in claim 1, wherein the main body is a first stage regulator.

3. The regulator assembly as claimed in claim 1, wherein the detecting device further comprises an outlet portion, and the outlet portion is located between the inlet portion and the outlet portion.

4. The regulator assembly as claimed in claim 3, wherein the detecting device further comprises at least one housing, the at least one housing is provided with the inlet portion and the outlet portion, and the chamber is formed between the inlet portion and the outlet portion.

5. The regulator assembly as claimed in claim 4, wherein the detecting device further comprises a first elastic member, wherein when the air provided by the air supply device is in a high-pressure state, the air drives the switch member to be in the first state with a first air pressure force, and the switch member presses the first elastic member to accumulate a predetermined elastic force, wherein when the air provided by the air supply device is in a low-pressure state, the first air pressure force decreases to a second air pressure force, and wherein the predetermined elastic force is greater than the second air pressure force, so that the switch member changes from the first state to the second state in response to release of the predetermined elastic force of the first elastic member.

6. The regulator assembly as claimed in claim 4, wherein the detecting device further comprises a first base and a second base which are arranged in the chamber, and wherein a predetermined space is defined between the first base and the second base and provided for the warning unit to move, and when the warning unit moves, the warning unit hits a first predetermined portion of one of the first base and the second base to emit a warning sound.

7. The regulator assembly as claimed in claim 6, wherein the detecting device further comprises a second elastic member for providing an elastic force to the warning unit.

8. The regulator assembly as claimed in claim 7, wherein the detecting device further comprises a retainer member arranged in the predetermined space, and the retainer member is configured to guide the warning unit on a path of movement.

9. The regulator assembly as claimed in claim 7, wherein the detecting device further comprises an auxiliary member, the auxiliary member is located between the chamber and the outlet portion, the auxiliary member comprises a predetermined section, and a predetermined gap is defined by the auxiliary member and the at least one housing, and wherein when the switch member is in the second state, the switch member allows the air to enter the chamber, and in a process that the air flows from the chamber to the outlet portion, the air drives the predetermined section of the auxiliary member to move in the predetermined gap.

10. The regulator assembly as claimed in claim 9, wherein the at least one housing comprises at least one predetermined hole communicating with the predetermined space, and wherein when the switch member is in the second state, the switch member allows the air to enter the chamber, and in a process that the air flows from the chamber to the outlet portion, through the at least one predetermined hole, the air drives the predetermined section of the auxiliary member to move in the predetermined gap.

11. The regulator assembly as claimed in claim 9, wherein size of the auxiliary member is greater than size of the second base, and the auxiliary member is sleeved to periphery of the second base.

12. The regulator assembly as claimed in claim 1, wherein an outlet portion of the detecting device is provided with a valve member.

13. The regulator assembly as claimed in claim 1 further comprising an electronic module, wherein the electronic module emits a predetermined signal according to activity of one of the warning unit and the switch member.

14. The regulator assembly as claimed in claim 13, wherein the predetermined signal comprises a sound or a light source.

15. The regulator assembly as claimed in claim 13, wherein the predetermined signal is received by an electronic device.

16. A detecting device, comprising:
a chamber;
a warning unit movably installed in the chamber; and
a switch member,
wherein when the switch member is in a first state, the switch member blocks a predetermined inlet of the chamber,
wherein when the switch member changes from the first state to a second state, the switch member does not block the predetermined inlet of the chamber, and
wherein a movement direction of the warning unit is substantially the same as a movement direction of the switch member.

17. The detecting device as claimed in claim 16, wherein the detecting device is connected to a first stage regulator through an inlet portion and communicates with an air channel of the first stage regulator, the switch member is located adjacent to the inlet portion, and the warning unit and the switch member are linearly aligned with each other.

18. The detecting device as claimed in claim 17 further comprising at least one housing, the at least one housing is provided with the inlet portion and an outlet portion, and the chamber is formed between the inlet portion and the outlet portion, wherein the detecting device further comprises a first elastic member providing an elastic force to the switch member, wherein the detecting device further comprises a second elastic member providing an elastic force to the warning unit, wherein the detecting device further comprises a first base and a second base which are arranged in the chamber, and wherein a predetermined space is defined between the first base and the second base and provided for the warning unit to move, and when the warning unit moves, the warning unit hits a first predetermined portion of one of the first base and the second base to emit a warning sound.

19. The detecting device as claimed in claim 18 further comprising an auxiliary member, the auxiliary member is located between the chamber and the outlet portion, size of the auxiliary member is greater than size of the second base, and the auxiliary member is sleeved to periphery of the second base, and wherein the auxiliary member comprises a base and a predetermined section connected to the base, a predetermined outlet is formed on the base, a predetermined gap is defined by the auxiliary member and the at least one housing, and the predetermined gap is provided for the auxiliary member to move in the predetermined gap.

20. A method for operating a regulator assembly, comprising:
providing a regulator assembly comprising a main body and a detecting device arranged in the main body, wherein the detecting device comprises a switch member, an elastic member, and a warning unit;
connecting an air channel of the main body to an air supply device;
in response to air provided by the air supply device being in a high-pressure state, driving the switch member to be in a first state by the air, and pressing the elastic member by the switch member to accumulate a predetermined elastic force; and
in response to the air provided by the air supply device being transformed from the high-pressure state to a low-pressure state due to consumption, the switch member changing from the first state to a second state in response to release of the predetermined elastic force of the elastic member, and the warning unit emitting a warning signal.
